(19) United States
(12) Patent Application Publication
(10) Pub. No.: US 2013/0030722 A1
(43) Pub. Date: Jan. 31, 2013

(54) MOBILE FLOW RATE MEASURING SYSTEM AND METHOD

(71) Applicants: Jin-Taek KIM, Suwon-si (KR); Ji-Yang Park, Daejeon (KR)

(72) Inventors: Jin-Taek KIM, Suwon-si (KR); Ji-Yang Park, Daejeon (KR)

(73) Assignee: Korea Rural Corporation, Uiwang-si (KR)

(21) Appl. No.: 13/440,400

(22) Filed: Apr. 5, 2012

(30) Foreign Application Priority Data
Jul. 28, 2011 (KR) 10-2011-0074989

(51) Int. Cl. G06F 19/00

(52) U.S. Cl. 702/45

(57) ABSTRACT

A mobile flow rate measuring system and method, which can recognize a flow rate at a site, and acquire and utilize data on water level, flow velocity, and flow rate of a plurality of agricultural waterways, by acquiring water level information and site features stored in a remote server from a tag installed at the site by a mobile apparatus and comparing images continuously acquired from the agricultural waterways through an image photographing camera to calculate the surface velocity of the waterway.

### CROSS-REFERENCE TO RELATED APPLICATIONS

This U.S. non-provisional patent application claims, priority under 35 U.S.C. §119 of Korean Patent Application No. 10-2011-0074989, filed on Jul. 28, 2011, the entire contents of which are hereby incorporated by reference.

### BACKGROUND OF THE INVENTION

The present invention disclosed herein relates to a mobile flow rate measuring system and method, and more particularly, to a mobile flow rate measuring system and method, which can recognize a flow rate at a site, and acquire and utilize data on water level, flow velocity, and flow rate of a plurality of agricultural waterways, by acquiring water level information and site features stored in a remote server from a tag installed at the site by a mobile apparatus and comparing images continuously acquired from the agricultural waterways through an image photographing camera to calculate the surface velocity of the waterway.

For quantitative plan and management of water resources in the agricultural field, continuous and, reliable data on, water level, flow velocity, and flow rate are important. Recently, real-time water level measurement using IT technology is becoming common.

The flow rate of the agricultural waterway is being measured using a current meter by which at least three to eight current courses have to be directly measured at a site, or a disposable rod float. However, there is a limitation in that this method needs much time and labor.

In order to overcome the limitation, various apparatuses for automatically measuring the flow rate are being developed. However, since such automatic measurement apparatuses are not only difficult to install, but also expensive to maintain, the apparatuses are not being widely used.

Recently, as a convenient and economical method for measuring the flow velocity, a Surface Image Velocimetry (SIV) method disclosed in Korean Patent Application No. 10-2008-0010579 has been developed. Since using a contactless type in measuring the flow velocity, this method has an advantage in that time and labor can be saved compared to a method of using a rod float. However, since this method is fundamentally for a flow velocity measurement, there still exists an inconvenience in that site measurement cross-sectional information has to be inputted whenever measurement is performed. Also, it is difficult to synchronize water level information varying according to the site's conditions, and recognize information of various points during photographing by equipment, and calculate the real-time flow rate to statistically use the measurement information.

### PRIOR ART

### Patent Document

1. Korean Patent No. 10-2008-0010579

### SUMMARY OF THE INVENTION

The present invention provides a system and method for simply measuring the flow rate in an agricultural waterway at a site and acquiring and using data on water level, flow velocity, and flow rate of various agricultural waterways.

Embodiments of the present invention provide mobile flow rate measuring systems including: a tag containing agricultural waterway identification information; a mobile apparatus including a camera configured to continuously photograph a site to acquire a video image of the site and recognize the tag to acquire the agricultural waterway identification information, and a transceiver transmitting the video image and the agricultural waterway identification information to a server and receiving data from the server; and a web server including: a transceiver receiving the video, image and the agricultural waterway identification information from the mobile apparatus and transmitting a result obtained by processing the video image and the agricultural waterway identification information to the mobile, apparatus; a database including site information on one or more agricultural waterways; and a processor receiving the video image and the agricultural waterway identification information from the mobile apparatus, calculating a flow velocity Using a Surface Image Velocimetry (SIV) method, extracting the site information from the database using the agricultural waterway identification information, calculating a flow rate using the calculated flow velocity and the site information, transmitting the calculated flow velocity, flow rate, and site information to the mobile apparatus through the transceiver, and storing the calculated flow velocity, flow rate, and site information in the database.

In some embodiments, the site information may include a width, a depth, and a water level of the waterway.

In other embodiments, the tag may include a Quick Response (QR) code, a bar code, a Radio Frequency (RF) tag, a ZigBee tag, and a Wireless Local Area Network (WLAN) tag.

In still other embodiments, the mobile apparatus may include a smart phone.

In other embodiments of the present invention, mobile flow rate measuring methods include: acquiring a video image of an agricultural waterway using a mobile apparatus including a camera; acquiring agricultural waterway identification information by recognizing a tag containing the agricultural waterway identification information using the mobile apparatus including the camera; transmitting the video image and the agricultural waterway identification information to a web server; calculating a flow velocity by analyzing the video image using a Surface Image Velocimetry (SIV) method; extracting site information on the agricultural waterway from a database storing site information on one or more agricultural waterways using the agricultural, waterway identification information; calculating a flow rate using the flow velocity and the site information; transmitting the calculated flow velocity, flow rate, or site information to the mobile apparatus; and storing the calculated, flow velocity, flow rate, or site information to the database.

In some embodiments, the site information may include a width, a depth, and a water level of the waterway.

In other embodiments, the tag may include a Quick. Response (QR) code, a bar code, a Radio Frequency (RF) tag, a ZigBee tag, and a Wireless Local Area Network (WLAN) tag.

In still other embodiments, the calculating of the flow rate may include calculating a flow rate using Equation (1):

Q=A·V (1)

where Q is the flow rate, A is a cross-sectional area, and V is the flow velocity.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a diagram illustrating a mobile flow rate measuring system according to an embodiment of the present invention;

FIG. 2 is a diagram illustrating an exemplary mobile flow rate measuring system according to an embodiment of the present invention;

FIG. 3 is a flowchart illustrating an exemplary mobile flow rate measuring method according to an embodiment of the present invention; and

FIG. 4 is a flowchart illustrating an exemplary Surface Image Velocimetry (SIV) method used in a mobile flow rate measuring method according to an embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Hereinafter, exemplary embodiments of the present invention will be described in detail with reference to the accompanying drawings.

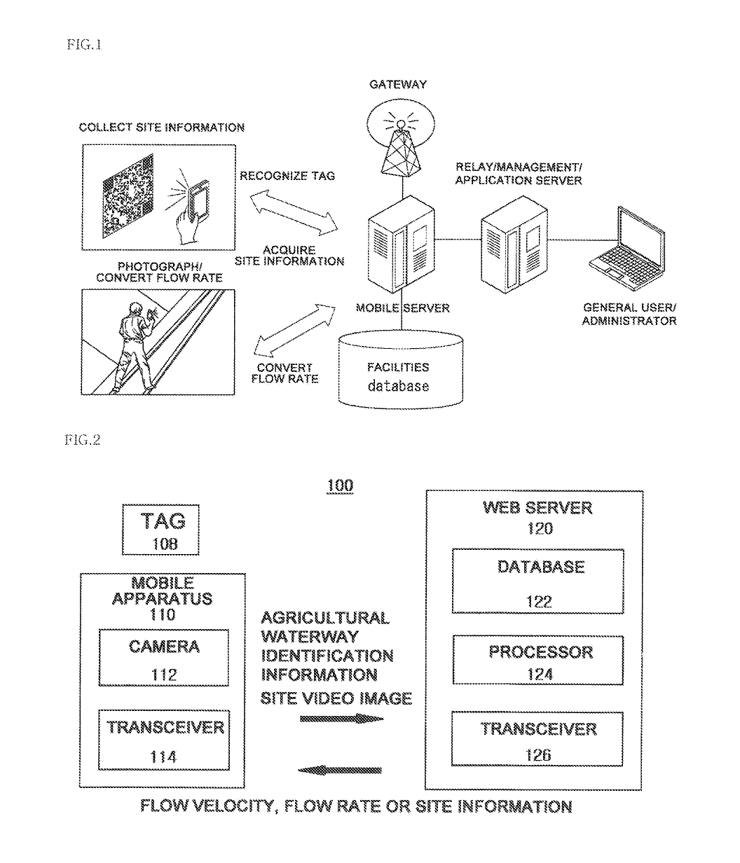

FIG. 1 is a diagram illustrating a mobile flow rate measuring system according to an embodiment of the present invention.

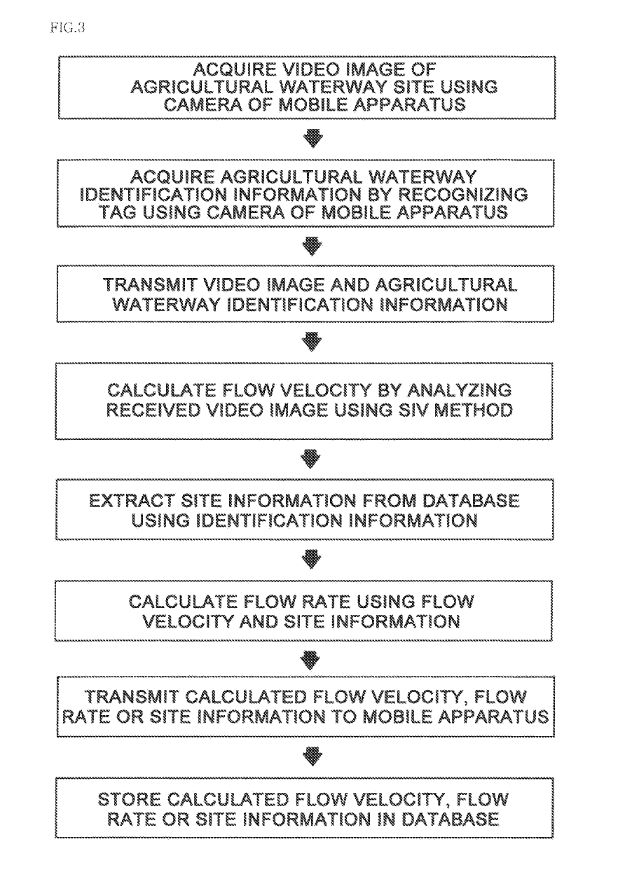

FIG. 2 is a diagram illustrating an exemplary mobile flow rate measuring system 100 according to an embodiment of the present invention. The mobile flow rate measuring system 100 may include a tag 108, a mobile apparatus 110, and a web server 120.

The mobile apparatus 110 may include a camera 112 and a transceiver 114. The camera 112 may photograph video image at a site, and may recognize the tag 108. The transceiver 114 may allow the mobile apparatus 110 to communicate with the web server 120. For example, the mobile apparatus 110 may be a smart phone.

The tag 108 may include waterway identification information. Accordingly, the mobile apparatus 110 may acquire the waterway identification information by recognizing the tag 108 through the camera 112. The tag 108 may be a Quick Response (QR) code, a barcode, a Radio Frequency (RF) tag, a ZigBee tag, or a Wireless Local Area Network (WLAN) tag according to its application.

The web server 120 may include a database 122, a processor 124, and a transceiver 126. The web server 120 may receive the video image and the waterway identification information from the transceiver 114 of the mobile apparatus 110 through the transceiver 126. The processor 124 of the web server 120 may calculate the flow velocity by analyzing the received video image using Surface Image Velocimetry (SIV) method. The web server 120 may extract the site information stored in the database 122 using the received waterway identification information. The site information may include the width, the depth, and the water level of a waterway. The web server 120 may calculate the flow rate using the calculated flow velocity and site information. The web server 120 may transmit the calculated flow velocity, flow rate, and site information to the mobile apparatus 110, and may simultaneously store the calculated flow velocity, flow rate, and site information in the database 122.

The database 122 may enable efficient and stable distribution management of agricultural waterways by integratedly managing the flow velocity, the flow rate, and the site information of a plurality of agricultural Waterways.

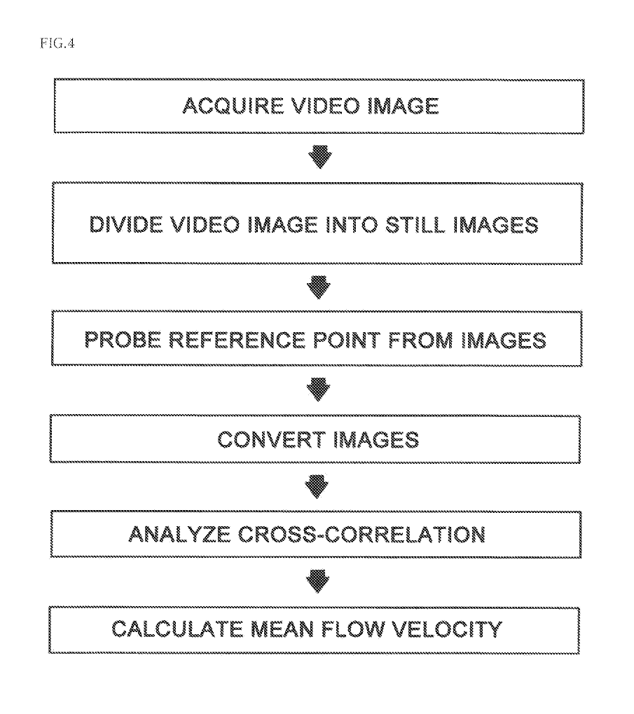

FIG. 3 is a flowchart illustrating an exemplary mobile flow rate measuring method according to an embodiment of the present invention.

First, a user may recognize a tag containing waterway identification information using a mobile apparatus including a camera. Thereafter, the user may continuously photograph a site using a camera of the mobile apparatus to acquire a video image of the site. The waterway identification information and the video image may be transmitted to a web server.

The web server may receive the waterway identification information and the video image. The web server may extract site information from a database using, the waterway identification information. The web server may calculate the cross-sectional area of the flow rate at the site, using site information, such as the width, the depth, and the water level of the waterway. As shown in FIG. 4, the flow velocity may be calculated using the received video image and the SIV method. Thereafter, the web server may calculate the flow rate by substituting the cross-sectional area and the flow velocity for Equation (1): Q=AV. Here, Q is the flow rate, A is the cross-sectional area, and V is the flow velocity. The web server may transmit the flow velocity, the flow rate, and the site information to the mobile apparatus of the user.

FIG. 4 is a flowchart illustrating an exemplary Surface Image Velocimetry (SIV) method used in a mobile flow rate measuring method according to an embodiment of the present invention. The SIV method may include acquiring a mobile video image, dividing the video image into still images, probing a reference point from the images, converting the images, analyzing a cross-correlation, and calculating a mean flow velocity. The SIV method is disclosed in more detail in Korean Patent Application No. 10-2008-0010579.

According to a mobile system and method for measuring the flow rate, a user may simply measure flow rate information on a plurality of site by recognizing a tag and photographing video image of a site using a portable mobile apparatus. Thus, the cost of installing and maintaining devices for measuring flow velocity and flow rate at a site can be reduced.

Also, the real-time information on a plurality of sites can be utilized by storing the flow rate and site information on the plurality of sites in an integrated database. Thus, efficient and stable distribution management of water can be achieved.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A mobile flow rate measuring system comprising:
a tag containing agricultural waterway identification information;
a mobile apparatus comprising a camera configured to continuously photograph a site to acquire a video image of the site and recognize the tag to acquire the agricultural waterway identification information, and a transceiver transmitting the video image and the agricultural waterway identification information to a server and receiving data from the server; and
a web server comprising:
a transceiver receiving the video image and the agricultural waterway identification information from the mobile apparatus and transmitting a result obtained by processing the video image and the agricultural waterway identification information to the mobile apparatus;
a database comprising site information on one or more agricultural waterways; and
a processor receiving the video image and the agricultural waterway identification information from the mobile apparatus, calculating a flow Velocity using a Surface Image Velocimetry (SIV) method, extracting the site information from the database using the agricultural waterway identification information, calculating a flow rate using the calculated flow velocity and the site information, transmitting the calculated flow velocity, flow rate, and site information to the mobile apparatus through the transceiver, and storing the calculated flow velocity, flow rate, and site information in the database.

2. The mobile flow rate measuring system of claim 1, wherein the site information comprises a width, a depth, and a water level of the waterway.

3. The mobile flow rate measuring system of claim 1, wherein the tag comprises a Quick Response (QR) code, a bar code, a Radio Frequency (RF) tag, a ZigBee tag, and a Wireless Local Area Network (WLAN) tag.

4. The mobile flow rate measuring system of claim 1, wherein the mobile apparatus comprises a smart phone.

5. A mobile flow rate measuring method comprising:
acquiring a video image of an agricultural waterway using a mobile apparatus including a camera;
acquiring agricultural waterway identification information by recognizing a tag containing the agricultural waterway identification information using the mobile apparatus including the camera;
transmitting the video image and the agricultural waterway identification information to a web server;
calculating a flow velocity by analyzing the video image using a Surface Image Velocimetry (SIV) method;
extracting site information on the agricultural waterway from a database storing site information on one or more agricultural waterways using the agricultural waterway identification information;
calculating a flow rate using the flow velocity and the site information;
transmitting the calculated flow velocity, flow rate, or site information to the mobile apparatus; and
storing the calculated flow velocity, flow rate, or site information to the database.

6. The mobile flow rate measuring method of claim 5, wherein the site information comprises a width, a depth, and a water level of the waterway.

7. The mobile flow rate measuring method of claim 5, wherein the tag comprises a Quick Response (QR) code, a bar code, a Radio Frequency (RF) tag, a ZigBee tag, and a Wireless. Local Area Network (WLAN) tag.

8. The mobile flow rate measuring method of claim 5, wherein the calculating of the flow rate comprises calculating a flow rate using Equation (1):
Q=A·V (1)
where Q is the flow rate, A is a cross-sectional area, and V is the flow velocity.
